(19) United States
(12) Patent Application Publication
(10) Pub. No.: US 2011/0133959 A1
(43) Pub. Date: Jun. 9, 2011

(54) UNOCCUPIED PARKING AREA NOTIFICATION SYSTEM AND METHOD FOR NOTIFYING INFORMATION ON UNOCCUPIED PARKING AREA

(75) Inventors: Kensuke Suzuki, Obu-city (JP); Toshiya Kawamura, Kariya-city (JP)

(73) Assignee: DENSO CORPORATION, Kariya-city (JP)

(21) Appl. No.: 12/959,693

(22) Filed: Dec. 3, 2010

(30) Foreign Application Priority Data
Dec. 4, 2009 (JP) 2009-276455
Sep. 24, 2010 (JP) 2010-213916

(51) Int. Cl. G08G 1/14

(52) U.S. Cl. 340/932.2

(57) ABSTRACT

A data generation unit generates parking schedule data, which includes information on an expected arrival time of a vehicle at a parking lot, for each vehicle being due to arrive at the parking lot. An arrival time calculation unit calculates an expected arrival time of a first vehicle at a parking lot. An unoccupied state calculation unit calculates a predicted value of an unoccupied state of the parking lot at the expected arrival time of the first vehicle, according to a number of expected parked vehicles, each having an expected arrival time before the expected arrival time of the first vehicle, and a present number of unoccupied parking cells in the parking lot. A notification unit provides a notification to a user of the first vehicle according to the calculated predicted value.

### CROSS REFERENCE TO RELATED APPLICATIONS

This application is based on and incorporates herein by reference Japanese Patent Applications. No. 2009-276455 filed on Dec. 4, 2009 and No. 2010-2113916 filed on Sep. 24, 2010.

### FIELD OF THE INVENTION

The present invention relates to an unoccupied parking area notification system. The present invention further relates to a method for notifying information on an unoccupied parking area.

### BACKGROUND OF THE INVENTION

For example, JP-A-2004-177199 discloses a conventional navigation device equipped in a vehicle and configured to obtain information on an unoccupied state of a parking lot (parking area) from an exterior source using a communication function. The obtained information is utilized for, for example, selection of a destination parking lot. It is noted that the conventionally used information on the unoccupied state of a parking lot is a subject when the information is generated. Therefore, even when the information on the unoccupied state of a certain parking lot specifies that an unoccupied space exists in the certain parking lot, the unoccupied space may be occupied when a vehicle arrives at the parking lot. That is, even when a parking lot is determined as a destination according to the information on the unoccupied state of the parking lot, the vehicle may arrive at the parking lot, which is already occupied completely.

### SUMMARY OF THE INVENTION

In view of the foregoing and other problems, it is an object of the present invention to produce an unoccupied parking area notification system configured to enable a vehicle not to arrive at a parking area being already occupied completely, even when the parking area is determined as a destination according to information on an unoccupied state of the parking area. It is another object of the present invention to produce a method for notifying information on an unoccupied parking area.

According to one aspect of the present invention, an unoccupied parking area notification system comprises a parking schedule data generation unit configured to generate parking schedule data for each vehicle being due to arrive at a parking area, the parking schedule data including information on an expected arrival time of a vehicle at the parking area. The unoccupied parking area notification system further comprises an arrival time calculation unit configured to calculate an expected arrival time of a first vehicle at the parking area. The unoccupied parking area notification system further comprises an expected unoccupied state calculation unit configured to calculate a predicted value of an unoccupied state of the parking area at the expected arrival time of the first vehicle, according to a number of expected parked vehicles in the parking schedule data and a present number of unoccupied parking cells in the parking area, the number of expected parked vehicles being a number of vehicles each having an expected arrival time before the expected arrival time of the first vehicle. The unoccupied parking area notification system further comprises a notification unit configured to provide a notification to a user of the first vehicle according to the calculated predicted value of the unoccupied state.

According to another aspect of the present invention, an unoccupied parking area notification system comprises a parking schedule data generation unit configured to: generate parking schedule data for each vehicle being due to arrive at one of a plurality of parking areas, the parking schedule data including information on an expected arrival time of a vehicle at a parking area; and add information to the parking schedule data of a parking area of the plurality of parking areas, the parking area having a parking space for disabled, the information being on whether the vehicle is due to be parked at the parking space for disabled. The unoccupied parking area notification system further comprises an indication unit configured to indicate preferentially on a user a parking area, which has a parking space for disabled, of a plurality of parking areas stored in a storage medium, according to that a predetermined flag stored in a storage medium is ON, the predetermined flag being switchable between ON and OFF according to an operation of a user of a first vehicle. The unoccupied parking area notification system further comprises an arrival time calculation unit configured such that, when one of the parking areas indicated by the indication unit is selected by a user, the arrival time calculation unit calculates an expected arrival time at the selected parking area. The unoccupied parking area notification system further comprises an expected unoccupied state calculation unit configured such that when the selected parking area has a parking space for disabled, the expected unoccupied state calculation unit calculates a predicted value of an unoccupied state of a parking space for disabled in the parking area at the expected arrival time of the first vehicle, according to a number of expected parked vehicles in the parking schedule data and a number of present unoccupied parking spaces for disabled in the parking area, the number of expected parked vehicles being a number of vehicles each being due to be parked at a parking space for disabled and having an expected arrival time before the expected arrival time of the first vehicle. The unoccupied parking area notification system further comprises a notification unit configured to provide a notification to a user of the first vehicle according to the calculated predicted value of the unoccupied state.

According to another aspect of the present invention, a method for notifying information on an unoccupied parking area, the method comprises generating parking schedule data for each vehicle being due to arrive at a parking area, the parking schedule data including information on an expected arrival time of a vehicle at the parking area. The method further comprises calculating an expected arrival time of a first vehicle at the parking area. The method further comprises extracting a number of expected parked vehicles, each having an expected arrival time before the expected arrival time of the first vehicle, from the parking schedule data. The method further comprises calculating a predicted value of an unoccupied state of the parking area at the expected arrival time of the first vehicle according to the number of expected parked vehicles and a present number of unoccupied parking cells in the parking area. The method further comprises providing a notification to a user of the first vehicle according to the calculated predicted value of the unoccupied state.

According to another aspect of the present invention, a method for notifying information on an unoccupied parking area, the method comprises generating parking schedule data for each vehicle being due to arrive at one of a plurality of parking areas, the parking schedule data including information on an expected arrival time of a vehicle at a parking area and information on whether the vehicle is due to be parked at a parking space for disabled in a parking area. The method further comprises extracting a parking area having a parking space for disabled from the plurality of parking areas and indicating preferentially on a user of a first vehicle the extracted parking area when a predetermined flag stored in a storage medium is set ON by the user. The method further comprises accepting one of the indicated parking areas selected by the user. The method further comprises calculating an expected arrival time of the first vehicle at the selected parking area. The method further comprises extracting a number of expected parked vehicles from the parking schedule data, the expected parked vehicles each being due to be parked at a parking space for disabled in the selected parking area before the expected arrival time of the first vehicle. The method further comprises calculating a predicted value of an unoccupied state of a parking space for disabled in the selected parking area at the expected arrival time of the first vehicle according to the number of expected parked vehicles and a number of present unoccupied parking spaces for disabled in the selected parking area. The method further comprises providing a notification to a user of the first vehicle according to the calculated predicted value of the unoccupied state.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a parking lot unoccupied state notification system according to an embodiment of the present invention;

FIG. 2 is a block diagram showing a configuration of a navigation device;

FIG. 3 is a block diagram showing a configuration of a center;

FIG. 4 is a view showing an example of configuration of parking-scheduled vehicle data;

FIG. 5 is a sequence chart showing a typical operation of the unoccupied parking lot information notification system;

FIG. 6 is a flow chart showing details of temporary determination and notification of a destination parking lot;

FIG. 7 is a flowchart showing calculation of an expected parked vehicles;

FIG. 8 is a sequence chart showing an operation when a vehicle arrives at a destination parking lot;

FIG. 9 is a sequence chart showing an operation when the vehicle cancels the destination parking lot;

FIG. 10 is a flow chart showing a disabled person recognition operation executed by a control circuit of a vehicular navigation device according to a second embodiment of the present invention;

FIG. 11 is a sequence chart showing a typical operation of the unoccupied parking lot information notification system, according to the second embodiment;

FIG. 12 is a view showing an example of configuration of parking-scheduled vehicle data, according to the second embodiment;

FIG. 13 is a flow chart showing details of temporary determination and notification of a destination parking lot, according to the second embodiment; and

FIG. 14 is a flow chart showing a destination set operation other than a parking lot.

### DETAILED DESCRIPTION OF PREFERRED EMBODIMENTS

### First Embodiment

As follows, the first embodiment will be described. FIG. 1 is an overview showing a parking lot unoccupied state notification system (unoccupied parking area notification system) according to the present first embodiment. As shown in FIG. 1, an unoccupied parking lot information notification system includes multiple vehicles 1, 2a to 2c, each equipped with a vehicular navigation device, and a center 4. The vehicular navigation device of each of the vehicles 1, 2a to 2c is communicable with the center 4 via a communication network such as a wide area network or an exclusive communication channels. The wide area network may include the Internet. The center 4 is located at a distant position from the vehicles 1, 2a to 2c. For example, the center 4 may be located inside a building.

In the present embodiment, the vehicular navigation devices of the vehicles 1, 2a to 2c have equivalent structures and functions. As follows, a specific vehicle 1 (first vehicle) among the vehicles is noted, and a structure and an operation of the vehicle 1 will be described.

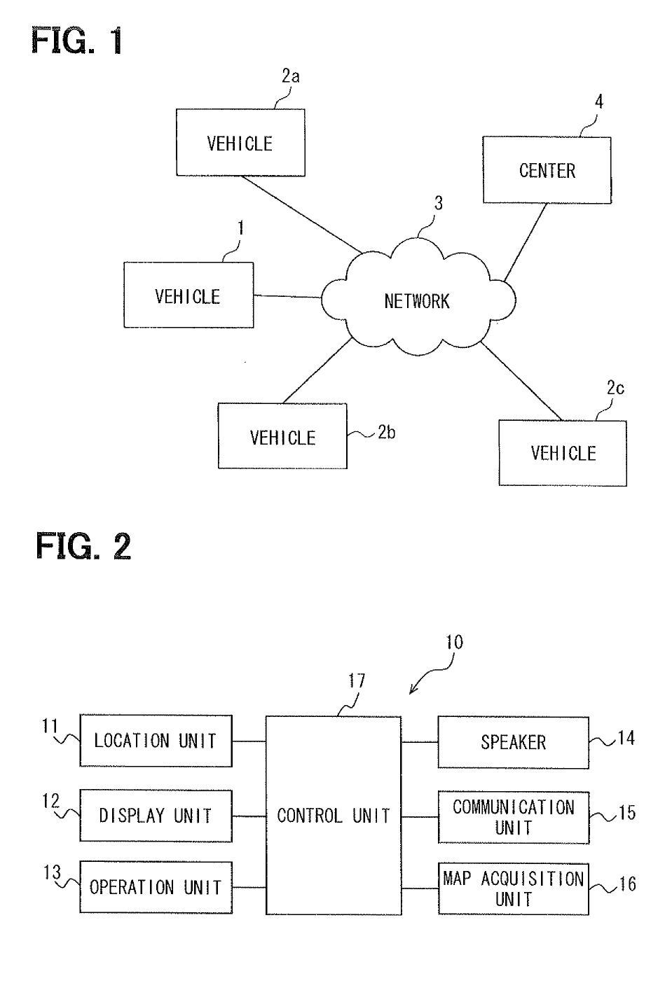

FIG. 2 is a block diagram showing a structure of a vehicular navigation device 10 commonly equipped in the vehicle 1 and another vehicle 2. The vehicular navigation device 10 equipped in a vehicle includes a position detection unit (location unit) 11, an image display unit 12, an operation unit 13, a speaker 14, a wireless communication unit (traffic information receiver) 15, a map data acquisition unit 16, and a control circuit 17.

The position detection unit 11 includes various generally-known sensors such as an acceleration sensor, a geomagnetism sensor, a gyroscope sensor, a vehicle speed sensor, and a GPS receiver. The position detection unit 11 generates information for identifying a current position of a vehicle, a direction of a vehicle, and speed of a vehicle based on the various sensors and outputs the information to the control circuit 17.

The image display unit 12 indicates an image on a user based on an image signal outputted from the control circuit 17. Specifically, the image display unit 12 may indicate, for example, a map around the present position.

The operation unit 13 may include an operation device including multiple mechanical switch devices equipped to the vehicular navigation device 10 and a touch panel equipped on a display surface of the image display unit 12. The operation unit 13 outputs a signal to the control circuit 17 according to depression of the mechanical switch device and touch of the touch panel by a user.

The wireless communication unit 15 is configured to perform wireless connection with a wireless-communication base station communicable with a communication network (internet or exclusive channel) 3 thereby to communicate with another communication device communicable with the communication network 3. The control circuit 17 utilizes the wireless communication unit 15 to communicate with the center 4 via the communication network 3.

The wireless communication unit 15 functions as a wireless receiver configured to receive vehicle information through a wireless communication from an FM radio station or an on-road apparatus located along a road. The wireless communication unit 15 is further configured to output the received vehicle information to the control circuit 17. The vehicle information is, for example, information of the vehicle information and communication system (VICS: Japanese traffic system) and may include traffic congestion information on a road, traffic restriction information, present unoccupied parking lot information, and the like. The present unoccupied parking lot information represents the number of unoccupied parking cells in each of multiple parking lots (parking areas). Each unoccupied parking cell corresponds to one vehicle. The present unoccupied parking lot information may include the total number of parking cells of a parking lot associated with the number of vehicles presently parked in the parking lot, from which the number of unoccupied parking cells can be calculated.

The map data acquisition unit 16 includes a nonvolatile storage medium, such as a DVD, a CD, and an HDD, and a data device configured to read data from the storage medium. The data device may be further configured to write data on the storage medium. The storage medium stores a program to be executed by the control circuit 17, map data for route guidance, and the like.

The map data includes road data and facility data. The road data includes various information such as position information on a link, classification information on a link, position information on a node, classification information on a node, and information on connection between a node and a link. Facility data includes multiple records, which respectively correspond to facilities. Each of the multiple records includes various information about a target facility related to, such as a name, a location, a land lot number, and a facility classification. The facility may include a parking lot, a department store, a picnic facility, and the like.

In the facility data, some of the multiple records of facilities include peripheral parking lot information representing a name, a location, and the like of one or more available parking lots (a tie-up parking lot, an exclusive parking lot, and the like) for using the facilities.

The control circuit 17 is, for example, a microcomputer including a CPU, a RAM, a ROM, a flash memory, an I/O device, and the like. The CPU reads a program from the ROM or the map data acquisition unit 16 and executes the program for an operation of the vehicular navigation device 10. In execution of the program, the CPU reads information from the RAM, the ROM, and the map data acquisition unit 16. Further, the CPU writes information in the RAM and a storage medium of the map data acquisition unit 16, if possible. Further, the CPU exchanges signals with the position detecting unit 11, the image display unit 12, the operation unit 13, the speaker 14, and the wireless communication unit 15.

Specifically, the control circuit 17 executes a program to perform a current position specifying operation, a map indicating operation, a destination determining operation, a guidance route calculating operation, a route guidance operation, and the like.

The current position specifying operation is performed for specifying the current position and a direction of the vehicle by using, for example, generally-known map matching, based on a signal from the position detecting unit 11. The map indicating operation is performed for indicating a map of a specific region, such as a peripheral area of the current position of the vehicle, on the image display unit 12. Information used for this map indicating operation is obtained from the map data.

The destination determining operation is performed for determining a destination according to a destination setting operation performed by a user to the operation unit 13. The guidance route calculating operation is performed for calculating an optimal guidance path from the present position to the destination. The route guidance operation is performed for outputting a guidance voice to instruct a right turn operation, a left turn operation, and the like via the speaker 14 and indicating an enlarged image of a guidance point on the image display unit 12 when the self-vehicle comes close to the guidance point such as a right-left-turn intersection on the guidance route so as to guide a driving operation of the vehicle along the guidance route.

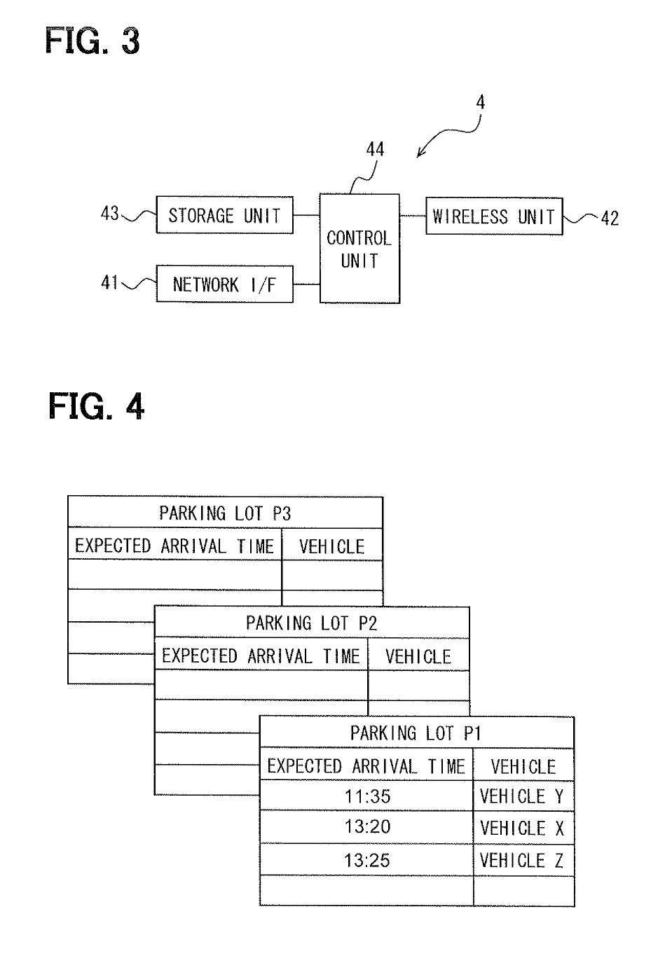

FIG. 3 is a block diagram showing the center 4. The center 4 includes a network interface 41, a wireless unit 42, a storage unit 43, and a control unit 44.

The network interface 41 is an interface circuit for connecting with the communication network 3 to perform communications through the communication network 3. The control unit 44 utilizes the communication network 3 to communicate with the vehicles 1, 2a to 2c through the communication network 3. The wireless unit 42 is a wireless receiver for receiving vehicle information such as the VICS information including the present unoccupied parking lot information and the like from an FM radio station and outputting the received VICS information to the control unit 44.

The storage unit 43 is a rewritable nonvolatile storage media such as a magnetic disc, a flash memory, or the like. The storage unit 43 stores multiple tables of parking schedule data. FIG. 4 is a view showing an example of configuration of parking-scheduled vehicle data. Each table of the parking schedule data corresponds to one of different parking lots. Each table of the parking schedule data includes identification information (vehicle identification information) of a vehicle and expected arrival time information on an expected arrival time of each vehicle, which is going to arrive at the corresponding parking lot. The identification information on a vehicle is for distinguishing the vehicle from other vehicles. The identification information on a vehicle may be an vehicular device ID stored in the ROM of the control circuit 17 of the vehicular navigation device 10 equipped to the vehicle.

The control unit 44 includes a CPU, a RAM, a ROM, and the like. The CPU of the control unit 44 executes a program stored in the ROM to execute a processing to be described later by using the network interface 41, the wireless unit 42, and the storage unit 43.

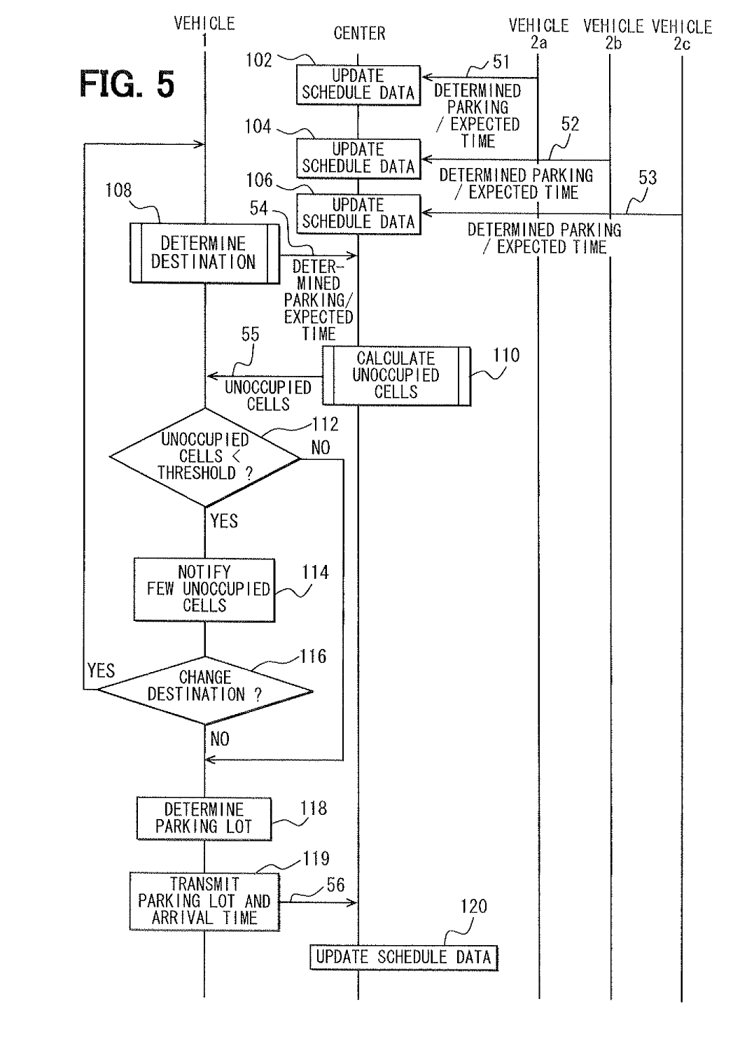

As follows, an operation of the unoccupied parking lot information notification system will be described. FIG. 5 is a sequence chart showing a typical operation of the unoccupied parking lot information notification system. First, the vehicular navigation device 10 equipped in the vehicles 2a to 2c communicates with the center 4 through the communication network 3 thereby to transmit signals 51, 52, 53 (first signal) to the center 4. The signals 51, 52, 53 include vehicle identification information on the vehicles 2a to 2c, parking lot identification information on a parking lot, which is determined as a destination of the vehicles 2a to 2c, and expected arrival time information on an expected arrival time of the vehicles 2a to 2c at the parking lot. The parking lot identification information on a parking lot may be information, such as a name, uniquely representing a parking lot.

At steps 102, 104, 106, the center 4 receiving the signals 51 to 53 reflects the received vehicle identification information, the received parking lot identification information, and the received expected arrival time information on the parking schedule data. Specifically, the center 4 identifies parking schedule data on a parking lot corresponding to the parking lot identification information in the received signals 51, 52, 53. In addition, the center 4 adds an entry to the parking schedule data. The entry includes a pair of the received vehicle identification information and the received expected arrival time information. In this way, information on a vehicle and arrival time of the vehicle is successively stored in corresponding parking schedule data of each parking lot. When the parking schedule data includes multiple entries, the multiple entries are sorted in order (ascending order) of the expected arrival time from early expected arrival time to late expected arrival time.

Details of the operation, when the vehicles 2a to 2c transmit signals 51 to 53 including the vehicle identification information, the parking lot identification information on a destination, and the expected arrival time information, and details of the operation, when the center 4 receives the signals 51 to 53 and reflects the received signals 51 to 53 on the parking schedule data, are the same as an operation of the self-vehicle 1 to transmit the vehicle identification information, the parking lot identification information on a destination, and the expected arrival time information as determined information and an operation of the center 4 to receive the transmitted determined information and reflect the received determined information on the parking schedule data to be described later.

Subsequently, at step 108, when a user of the self-vehicle 1 performs a setting operation of a destination parking lot to a vehicular navigation device 10 (one example of first vehicular navigation device) of the self-vehicle 1, the vehicular navigation device 10 temporarily determines the destination parking lot according to the setting operation. Further, the vehicular navigation device 10 transmits the vehicle identification information on the self-vehicle 1, the parking lot identification information on the temporarily determined destination parking lot, and the information on the expected arrival time when the self-vehicle 1 arrives at the destination parking lot to the center 4. The present operation may be equivalent to a part of the above-described destination determining operation.

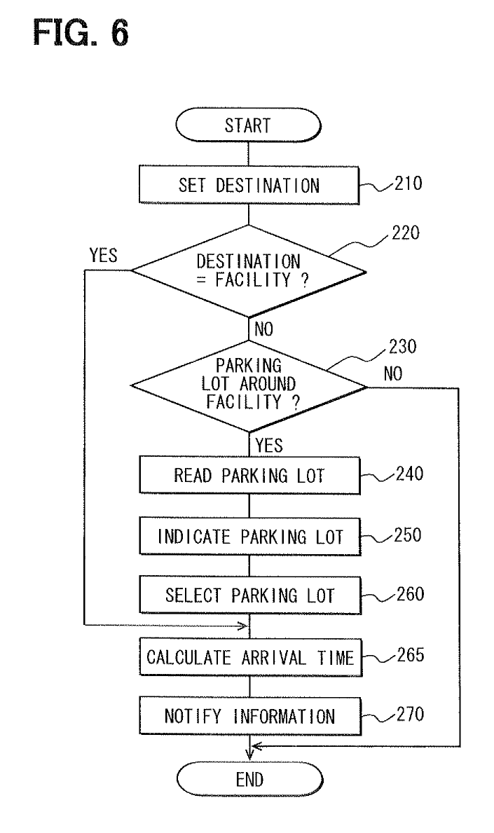

FIG. 6 is a flowchart showing a detail of an operation of destination parking lot temporary determination and notification at step 108. At step 210, the control circuit 17 first accepts a setting operation of a main destination performed by a user to the operation unit 13. Subsequently, the control circuit 17 sets the main destination according to the accepted setting operation. The main destination may be a parking lot or a facility provided with an available parking lot (tie-up parking lot and/or the like) around the facility.

At step 220, the control circuit 17 subsequently determines whether the set main destination is a parking lot. When the control circuit 17 determines that the set main destination is a parking lot, at step 265, the control circuit 17 calculates an expected arrival time at the parking. The expected arrival time may be calculated by executing a guidance route calculating operation to calculate an optimal guidance path from the present position of the self-vehicle 1 to the parking lot, calculating a time period (required traveling time) required to travel along the calculated guidance path, and calculating a time point advanced from the present time by the calculated required traveling time. The required traveling time may be calculated in various ways. For example, the required traveling time may be calculated by dividing a total distance of the guidance path by an average speed.

At step 270, the control circuit 17 further transmits a signal 54 (a second signal) to the center 4. The signal 54 includes the vehicle identification information on the self-vehicle, the parking lot identification information on the parking lot, and the expected arrival time at the parking lot calculated at step 265. Thus, the operation of destination parking lot temporary determination and notification is terminated.

Alternatively, when the presently set main destination is not a parking lot but a facility, the processing proceeds to step 230. At step 230, the control circuit 17 determines whether the facility, which is presently set as the main destination, has an available parking lot for use of the facility according to existence of the peripheral parking lot information on the facility in the map data. When there is no available parking lot, the destination parking lot temporary determination and notification is terminated. In this case, the control circuit 17 does not execute the processing of step 108 and subsequent processings in FIG. 5.

When there is an available parking lot, the processing proceeds to step 240. At step 240, the control circuit 17 reads parking lot identification information on all peripheral parking lots around the facility. Subsequently, at step 250, the control circuit 17 causes the image display unit 12 to indicate a list of presently read information on a name of the parking lot, a location of the parking lot, and the like. Subsequently, at step 260, the control circuit 17 waits for an action made by a user using the operation unit 13 to select one of the parking lots in the indicated list. On selection by the user, at step 265, the control circuit 17 calculates an expected arrival time at the parking lot. Further, at step 270, the control circuit 17 transmits the signal 54 to the center 4. The signal 54 includes the vehicle identification information on the self-vehicle, the parking lot identification information, and the expected arrival time at the selected parking lot. Thus, the control circuit 17 terminates the destination parking lot temporary determination and notification.

In this way, the control circuit 17 determines one of a parking lot, which is a main destination selected by a user, and a parking lot available for use of a facility, which is a main destination selected by a user. Further, the control circuit 17 transmits (FIG. 5) the signal 54 to the center 4 through the communication network 3. The signal 54 includes the vehicle identification information on the self-vehicle, the parking lot identification information on the determined parking lot, and the expected arrival time at the determined parking lot.

At step 110, on receiving the signal 54, the control unit 44 of the center 4 subsequently calculates the number of expected unoccupied parking cells in the parking lot included in the signal 54. Each unoccupied parking cell corresponds to one vehicle. The control unit 44 further transmits a signal 55 to the vehicular navigation device 10. The signal 55 includes the calculated number of the expected unoccupied parking cells.

The number of expected unoccupied parking cells in a parking lot calculated at the step 110 is a predicted value of unoccupied parking cells in the parking lot at an expected arrival time when the vehicle 1 arrives at the parking lot. The number of expected unoccupied parking cells is calculated according to the number of unoccupied parking cells (present unoccupied cells C) in the present parking lot and the number of other vehicles (expected parked vehicles F) expected to be parked in the parking lot by the time point when the self-vehicle 1 arrives at the parking lot. Specifically, the number of expected unoccupied parking cells is calculated by subtracting the expected parked vehicles F from the present unoccupied cells C. It is noted that a vehicle, which does not have a function to transmit the parking lot identification information on the destination parking lot to the center 4, may be parked in the parking lot. In consideration of this, the number of expected unoccupied parking cells may be calculated by subtracting a value, which is obtained by multiplying the expected parked vehicles F by a coefficient K greater than 1, from the present unoccupied cells C.

In the present example, the present unoccupied parking lot information on the parking lot is extracted from the VICS information received by the wireless unit 42, and the extracted present unoccupied parking lot information is employed as the present unoccupied cells C. The expected parked vehicles F is calculated according to the parking schedule data of the parking lot stored in the storage unit 43. Specifically, the number of entries, each having expected arrival time before the expected arrival time when the self-vehicle 1 arrives at the parking lot, is obtained from the parking schedule data, and the obtained number may be employed as the expected parked vehicles F.

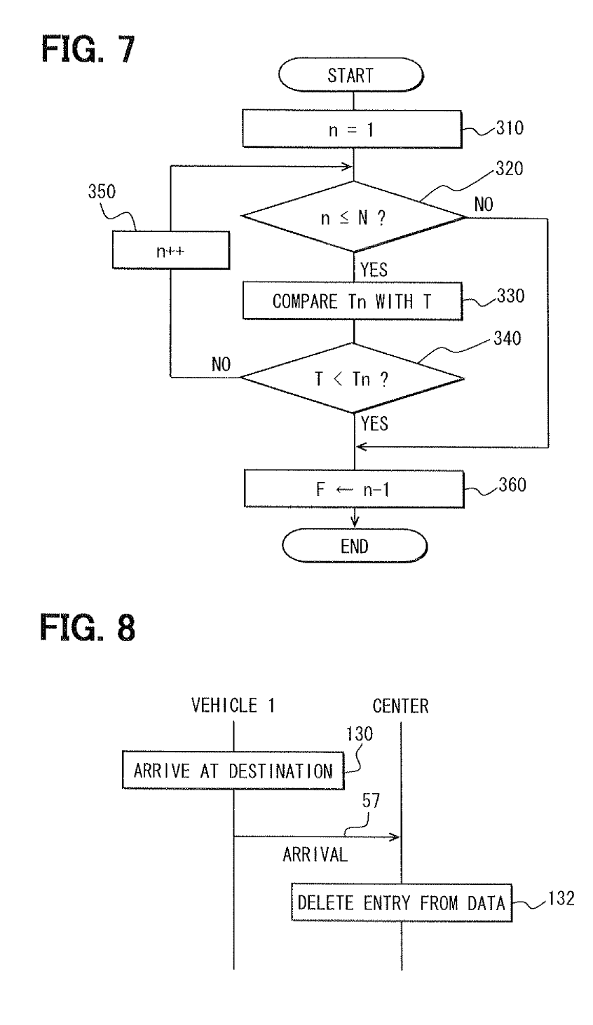

FIG. 7 is a flowchart showing calculation of the expected parked vehicles F. At step 310, the control unit 44 first initializes a processing variable n at 1. Subsequently, at step 320, the control unit 44 compares the variable n with a total entry number N in the parking schedule data to determine whether a relation of n≦N is satisfied. When the relation of n≦N is satisfied, the processing proceeds to step 330. At step 330, the control unit 44 subsequently compares an expected arrival time T(n), which corresponds to the nth entry in the parking lot expected data, with the expected arrival time T of the vehicle 1 included in the received signal 54.

The parking lot expected data includes entries sorted in order (ascending order) from early expected arrival time to late expected arrival time. Therefore, the expected arrival time of the nth entry corresponds to nth arrival of another vehicle of an entry in the parking lot expected data.

Subsequently, at step 340, the control unit 44 determines whether the expected arrival time T is earlier than the expected arrival time T(n). When the expected arrival time T is not earlier than the expected arrival time T(n), the processing proceeds to step 350. At step 350, the control unit 44 increments the variable n by one. Thus, the processing is returned to step 320.

In this way, the control unit 44 compares the expected arrival time T of the vehicle 1 with the expected arrival time T(n) included in the parking lot expected data in ascending order at step 330. Each time when it is determined that the expected arrival time T(n) is not earlier than the expected arrival time T (step 340: NO), the variable n is incremented by one at step 350. When the variable n becomes greater than the total entry number N (step 320: NO), the processing proceeds from step 320 to step 360, since there is no object to be compared. In this case, at step 360, the control unit 44 employs a value, which is calculated by subtracting one from the variable n, as the expected parked vehicles F. That is, the control unit 44 employs the total entry number N as the expected parked vehicles F. The processing is executed in this way, since the expected arrival times of all the entries included in the parking lot expected data are earlier than the expected arrival time of the vehicle 1 in this case.

When the control unit 44 determines that the expected arrival time T is earlier than the expected arrival time T(n) at step 340, the processing proceeds to step 360. In this case, at step 360, the value, which is calculated by subtracting one from the variable n, is employed as the expected parked vehicles F. The processing is executed in this way, since the expected arrival times of only n−1 entries in the parking lot expected data are earlier than the expected arrival time of the vehicle 1 in this case.

Subsequent to step 360, the control unit 44 terminates the calculation of the expected parked vehicles. F. Thus, the control unit 44 calculates the number of expected unoccupied parking cells in the parking lot according to the expected parked vehicles F and the present unoccupied cells C. Further, the control unit 44 transmits the signal 55 (FIG. 5) including the information on the calculated number of expected unoccupied parking cells to the vehicle 1 through the communication network 3.

When the vehicular navigation device 10 of the self-vehicle 1 receives the signal 55, at step 112, the control circuit 17 of the vehicular navigation device 10 determines whether the received number of expected unoccupied parking cells in the parking lot is less than a predetermined number, such as one or five. When the control circuit 17 determines that the received number of expected unoccupied parking cells is not less than the predetermined number, the processing proceeds to step 118. At step 118, the control circuit 17 determines the parking lot as a destination. The control circuit 17 further calculates the expected arrival time at the parking lot (determined destination). Further, at step 119, the control circuit 17 transmits a signal 56 (one example of first signal) to the center 4 through the communication network 3. The signal 56 includes the vehicle identification information on the self-vehicle 1, the parking lot identification information on the parking lot, and the expected arrival time at the parking lot. Subsequently, the control circuit 17 performs a route guidance operation along an optimal guidance path from the present position to the parking lot.

On receiving the signal 56, the control unit 44 of the center 4 updates parking schedule data of the parking lot. Specifically, at step 120, the control unit 44 adds an entry, which includes a pair of the vehicle identification information and the expected arrival time information included in a signal 65, to the parking schedule data, which corresponds to the parking lot identification information on the parking lot included in the received signal 65. The new entry is added to a position, which is subsequent to all entries, each including an expected arrival time earlier than the arrival time of the new entry, and in advance of all the entries, each including an expected arrival time later than the arrival time of the new entry. The new entry is added in this way. Thereby, entries are stored in the parking schedule data in ascending order of the expected arrival time.

At step 112, when the control circuit 17 of the vehicular navigation device 10 equipped in the self-vehicle 1 determines that the received number of expected unoccupied parking cells in the parking lot is less than the predetermined number, the processing proceeds to step 114. At step 114, the control circuit 17 causes the image display unit 12 and the speaker 14 to output an image and/or a voice to notify a user of information that the parking lot, which is temporarily determined as a destination, has a small number of unoccupied parking cells. At this time, the number of expected unoccupied parking cells, which is currently calculated, may be indicated.

Further, at step 116, the control circuit 17 causes the image display unit 12 and the speaker 14 to inquire a user whether to change the parking lot (destination) and recommends the user to change the destination parking lot. Thus, the control circuit 17 waits for a reply operation with respect to the inquiry. When the user performs reply operation to the operation unit 13 to change the destination parking lot, the processing returns to step 108 again. Thus, temporary determination of a new destination parking lot is performed again.

When the user performs reply operation to the operation unit 13 not to change the destination parking lot, the processing proceeds to step 118. At step 118, the parking lot is determined as a destination parking lot. In this case, at step 119, the control circuit 17 transmits the signal 56, which includes the vehicle identification information on the self-vehicle 1, the parking lot identification information on the parking lot, and the expected arrival time at the parking lot, to the center 4 through the communication network 3. Subsequently, the control circuit 17 performs a route guidance operation along an optimal guidance path from the present position to the parking lot. In this way, even when it is highly possible that there is no unoccupied parking cell when the vehicle arrives at the parking lot, route guidance can be performed to the parking lot in a condition where a user determine to go to the parking lot daringly.

As shown in FIG. 8, at step 130, when the self-vehicle 1 arrives at the destination parking lot, the control unit 44 of the self-vehicle 1 transmits a signal 57 to the center 4. The signal 57 includes arrival information, which represents that the vehicle arrives at the destination parking lot, and the vehicle identification information on the self-vehicle 1. At step 132, on receiving the signal 57, the control unit 44 of the center 4 searches parking schedule data, which includes the entry of the vehicle identification information on the vehicle 1. That is, the control unit 44 searches parking schedule data of the destination parking lot of the vehicle 1. Further, the control unit 44 deletes the entry, which is found as a result of the search, from the parking schedule data. The present operation of the vehicle 1 is applied to the vehicles 2a to 2c.

In this way, when a vehicle, which corresponds to vehicle identification information included in a certain entry registered in the parking schedule data of a certain parking lot, arrives at the parking lot, the vehicular navigation device 10 of the vehicle transmits arrival information and vehicle identification information to the center 4. On receiving the arrival information and the vehicle identification information, the center 4 deletes the entry of the vehicle from the parking schedule data. The entry of the vehicle, which has already arrived at the destination parking lot, is deleted from the parking schedule data in this way. Thereby, the number of the entries of the parking schedule data can be restricted from increasing endlessly.

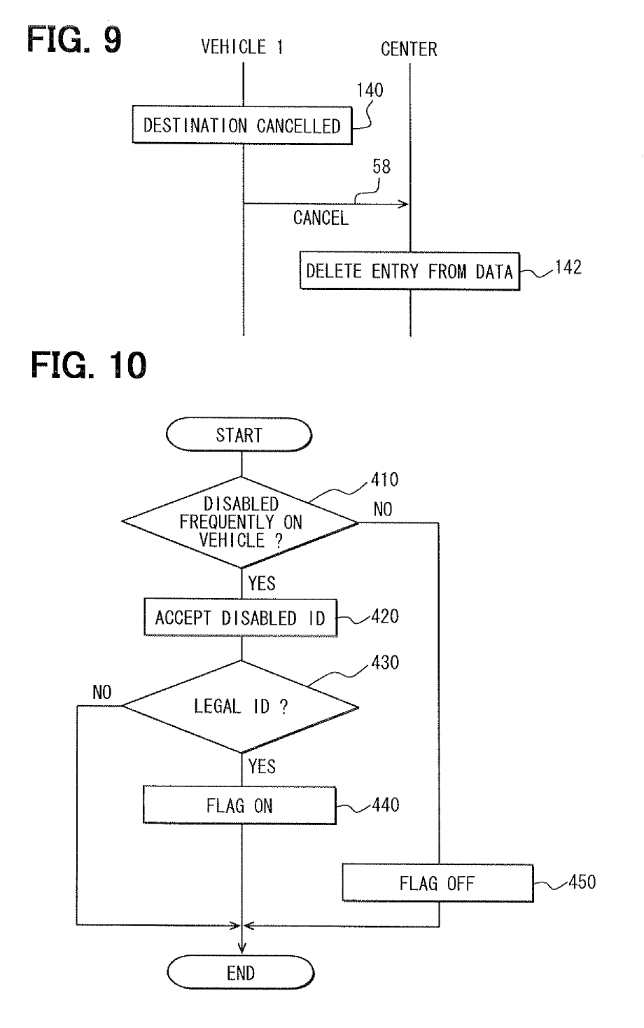

As shown in FIG. 9, when an occupant of the self-vehicle 1 performs operation to the operation unit 13 to cancel setting to the destination, the processing proceeds to step 140. At step 140, the control circuit 17 transmits a signal 58 to the center 4. The signal 58 includes cancellation information, which represents cancellation of setting of a destination parking lot, and the vehicle identification information on the self-vehicle 1. At step 142, on receiving the signal 58, the control unit 44 of the center 4 searches parking schedule data, which includes the entry of the vehicle identification information on the vehicle 1. That is, the control unit 44 searches parking schedule data of the destination parking lot of the vehicle 1. Further, the control unit 44 deletes the entry, which is found as a result of the search, from the parking schedule data. The present operation of the vehicle 1 is applied to the vehicles 2a to 2c.

In this way, when a driver cancels setting of a destination parking lot in a vehicle, which corresponds to vehicle identification information included in a certain entry registered in the parking schedule data of a certain parking lot, the vehicular navigation device 10 of the vehicle transmits cancellation information and vehicle identification information to the center 4. On receiving the cancellation information and the vehicle identification information, the center 4 deletes the entry of the vehicle from the parking schedule data. The entry of the vehicle, which will not arrive at the destination parking lot, is deleted from the parking schedule data in this way. Thereby, the number of the entries of the parking schedule data can be restricted from increasing endlessly.

As described above, according to the unoccupied parking lot information notification system of the present embodiment, the center 4 receives the signals 51, 52, 53, 56 from the vehicular navigation devices 10 equipped in the vehicles 1, 2a to 2c. The signals 51, 52, 53, 56 include the vehicle identification information and the information on the expected arrival time at a destination parking lot of the vehicles equipped with the vehicular navigation device 10. Further, on receiving the signals 51, 52, 53, 56, the center 4 adds an entry, which includes a pair of the vehicle identification information and the expected arrival time information in the received signals 51, 52, 53, 56, to the parking schedule data corresponding to the parking lot.

The vehicular navigation device 10 of the vehicle 1 calculates the expected arrival time at the parking lot of the self-vehicle 1, which is temporarily determined as the destination. The vehicular navigation device 10 further transmits the signal 54, which includes the calculated expected arrival time at the parking lot and the vehicle identification information on the vehicle 1, to the center 4.

On receiving the signal 54, the center 4 calculates a predicted value of unoccupied parking cells in the parking lot at the expected arrival time. The center 4 further transmits the calculated predicted value of the unoccupied parking cells to the vehicle 1.

On receiving the predicted value of the unoccupied parking cells from the center 4, the vehicular navigation device 10 of the vehicle 1 notifies a user in the vehicle 1 of the predicted value of unoccupied parking cells. Further, the vehicular navigation device 10 temporarily determines another parking lot as a destination parking lot according to a user's operation.

According to the present configuration, the number of other vehicles (expected parked vehicles) 2, which are not in a parking lot presently and going to be in the parking lot before the vehicle 1 arrives at the parking lot, can be predicted while the vehicle 1 is going to the parking lot. Thereby, in consideration of the expected parked vehicles, a user can be notified of a quantity of unoccupied parking cells at the time point where the vehicle 1 arrives at the parking lot. Therefore, it is less possible that the vehicle finally arrives at a completely occupied parking lot, compared with determination of a parking lot according to a present unoccupied state of the parking lot.

In addition, a user is recommended to change a destination parking lot to another parking lot, when it is expected that the destination parking lot be congested. Thereby, congestion can be avoided beforehand in actual parking lot.

Further, the center 4 manages the parking lot expected data all together. Thereby, the vehicular navigation devices 10 of the vehicles 1, 2a to 2c need not to communicate with each other. Therefore, operation for communications can be simplified.

In the present embodiment, the control unit 44 of the center 4 executes the operations of steps 102, 104, 106, 120 to function as one example of a parking schedule data generation unit. In addition, the control unit 44 of the center 4 executes the operation of step 110 to function as one example of an expected unoccupied state calculation unit.

The control circuit 17 of the vehicular navigation device 10 executes the operation of step 265 to function as one example of an arrival time calculation unit. The control circuit 17 of the vehicular navigation device 10 executes the operation of step 270 to function as one example of a transmission unit. The control circuit 17 of the vehicular navigation device 10 executes the operation of step 114 to function as one example of a notification unit.

### Second Embodiment

Next, the second embodiment of the present invention will be described. The present embodiment is produced by modifying the first embodiment so as to enhance convenience for a disabled person in a vehicle. The hardware configuration of the parking lot unoccupied state notification system in the present embodiment is equivalent to that of the first embodiment. Therefore, the hardware configurations of the center 4 and the vehicular navigation device 10 in the present embodiment are equivalent to those of the first embodiment.

As follows, an operation of the unoccupied parking lot information notification system according to the present embodiment will be described mainly about difference from the first embodiment.

First, in the vehicular navigation device 10 of the present embodiment, the control circuit 17 executes a disabled person recognition operation shown in FIG. 10. The disabled person recognition operation is for switching a disabled person flag, which is one example of a predetermined flag. The disabled person flag represents that a disabled person frequently rides on the self-vehicle 1 equipped with the vehicular navigation device 10. Specifically, in the disabled person recognition operation, the disabled person flag is switched between an ON state and an OFF state according to a user's operation.

The control circuit 17 starts execution of the disabled person recognition operation when the operation unit 13 accepts a predetermined operation. Specifically, at step 410, the control circuit 17 first causes a voice and/or an image to inquire a user whether a disabled person frequently rides on the self-vehicle 1. The control circuit 17 waits until the user operates the operation unit 13 to respond to the inquiry. When the operation unit 13 accepts an operation representing that a disabled person frequently rides on the self-vehicle 1, the processing proceeds to step 420. Alternatively, when the operation unit 13 accepts an operation representing that a disabled person does not frequently ride on the self-vehicle 1, the processing proceeds to step 450.

At step 420, the control circuit 17 causes a voice and/or an image to request a user to input a registration ID specified by a disabled person ID item such as a card or a note and waits for input of the disabled person's ID to the operation unit 13. When a user inputs a registration ID specified by a disabled person ID item of the user to the operation unit 13, the processing proceeds to step 430.

At step 430, the control circuit 17 determines whether the inputted registration ID is a registration ID of a legal disabled person ID item validly registered in a governmental office such as a prefecture office. The present determination whether the inputted registration ID is a legal registration ID may be made by determining whether the inputted registration ID is included in a legal registration ID list. The legal registration ID list includes legal registration IDs beforehand stored in a storage medium such as a ROM or a flash memory of the control circuit 17, or an HDD of the map data acquisition unit 16. Alternatively, the following operation may be performed. The control circuit 17 may cause the wireless communication unit 15 to transmit an inquiry signal, which includes the inputted registration ID, to a disabled person registration ID provider server located outside the vehicle. In this case, the disabled person ID provider server stores the list and determines whether the list includes the registration ID included in the received inquiry signal. Subsequently, the disabled person ID provider server may transmit a determination result to the vehicular navigation device 10 via wireless communications. Subsequently, the control circuit 17 of the vehicular navigation device 10 may determine whether the list includes the inputted registration ID according to the received determination result. On determination that the inputted ID is a legal registration ID, the processing proceeds to step 440. At step 440, the disabled person flag stored in the flash memory or the HDD of the map data acquisition unit 16 is set ON. Thus, the disabled person recognition operation is terminated.

The operation of the control circuit 17 enables registration of frequent ride of a user being a disabled person. An initial value of the disabled person flag is set OFF at the time of shipment of the vehicular navigation device 10.

When the control circuit 17 determines that the inputted ID is not a legal registration ID at step 430, the disabled person recognition operation is terminated without switching the disabled person flag. In this way, invalid operation to set the disabled person flag ON can be avoided.

When the control circuit 17 determines that a disabled person does not frequently ride on the self-vehicle 1 at step 410, the processing proceeds at step 450. At step 450, the disabled person flag is set OFF, and the disabled person recognition operation is terminated. In this way, the disabled person flag can be set OFF from the ON state according to the user's operation.

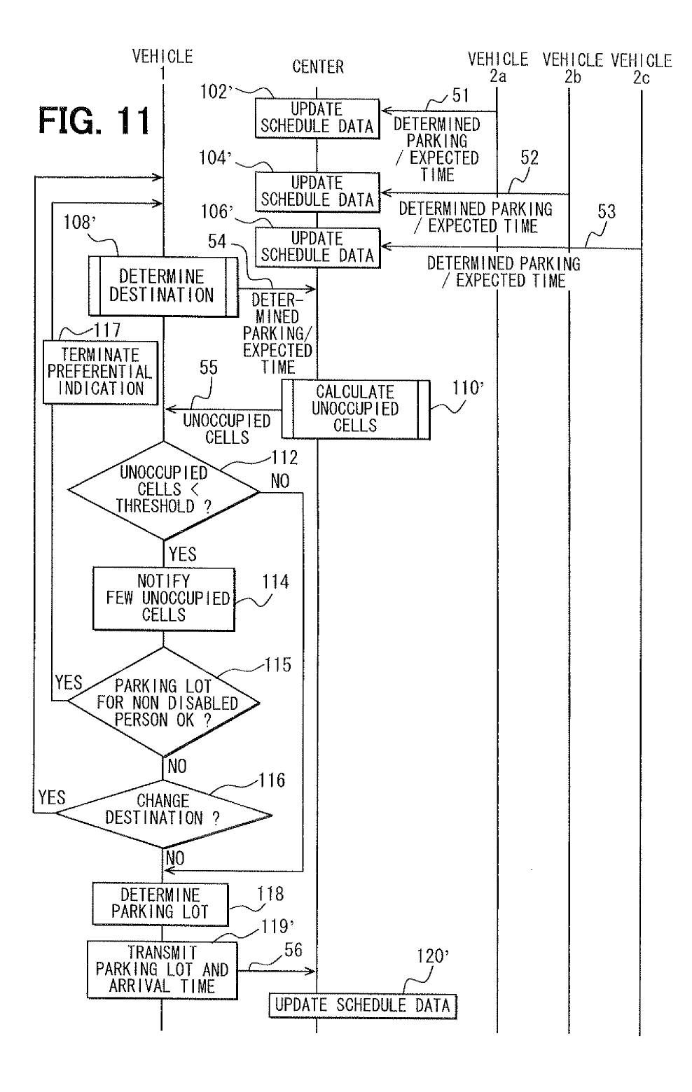

Next, operation of the unoccupied parking lot information notification system shown in FIG. 11 will be described. FIG. 11 is a sequence chart showing a typical operation of the unoccupied parking lot information notification system when the disabled person flag is ON. Steps of operations in FIG. 11 same as those in FIG. 5 in the first embodiment are denoted by the same reference numerals, and description about the same steps in FIG. 5 is omitted.

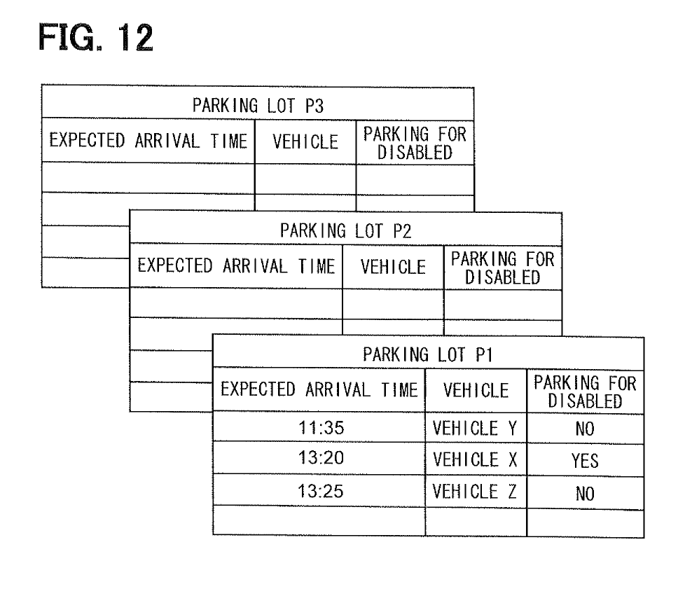

FIG. 12 is a view showing an example of configuration of parking-scheduled vehicle data according to the present embodiment. Each table of the parking schedule data corresponds to one of different parking lots. Each table of the parking schedule data includes the identification information (vehicle identification information) of a vehicle, information on an expected arrival time of each vehicle, which is going to arrive at the corresponding parking lot, and whether each vehicle is going to be parked at a parking space (parking cell) for disabled. The parking space for disabled is an, exclusive parking cell only for a disabled person.

The control unit 44 of the center 4 generates the parking schedule data as follows. As shown in FIG. 11, the vehicular navigation device 10 equipped in the vehicles 2a to 2c first communicates with the center 4 through the communication network 3 thereby to transmit signals 51, 52, 53 (first signal) to the center 4. The signals 51, 52, 53 include vehicle identification information on the vehicles 2a to 2c, parking lot identification information on a parking lot, which is determined as a destination of the vehicles 2a to 2c, expected arrival time information on an expected arrival time of the vehicles 2a to 2c at the parking lot. The signals 51, 52, 53 further include information on whether the vehicle is going to be parked at a parking space for disabled. The parking lot identification information on a parking lot may be information, such as a name, uniquely representing a parking lot.

At steps 102′, 104′, 106′, the center 4 receiving the signals 51 to 53 reflects the received vehicle identification information, the received parking lot identification information, and the received expected arrival time information on the parking schedule data. Specifically, the center 4 identifies parking schedule data on a parking lot corresponding to the parking lot identification information in the received signals 51, 52, 53. In addition, the center 4 adds an entry to the parking schedule data. The entry includes the received vehicle identification information, the received expected arrival time information, and information on whether the vehicle is going to be parked at a parking space for disabled. In this way, information on a vehicle and arrival time of the vehicle and information on whether the vehicle is going to be parked at a parking space for disabled are successively stored in corresponding parking schedule data of each parking lot. When the parking schedule data includes multiple entries, the multiple entries are sorted in order (ascending order) of the expected arrival time from early expected arrival time to late expected arrival time.

Details of the operation, when the vehicles 2a to 2c transmit signals 51 to 53 including the vehicle identification information, the parking lot identification information on a destination, and the expected arrival time information and the information on whether the vehicle is going to be parked at a parking space for disabled, and details of the operation, when the center 4 receives the signals 51 to 53 and reflects the received signals 51 to 53 on the parking schedule data, are the same as an operation of the self-vehicle 1 to transmit the vehicle identification information, the parking lot identification information on a destination, and the expected arrival time information as determined information and an operation of the center 4 to receive the transmitted determined information and reflect the received determined information on the parking schedule data to be described later.

When a user of the self-vehicle 1 performs a setting operation of a destination parking lot to the operation unit 13 of the vehicular navigation device (one example of first vehicular navigation device) 10 of the self-vehicle 1, the control circuit 17 of the vehicular navigation device 10 executes processings such as steps 108 to 119 in FIG. 11 when the disabled person flag is ON and executes processings such as steps 108 to 119 in FIG. 5 in the first embodiment when the disabled person flag is OFF.

Similarly to step 108 in FIG. 5, at step 108′, the vehicular navigation device 10 temporarily determines the destination parking lot according to the setting operation. Further, the vehicular navigation device 10 transmits the vehicle identification information on the self-vehicle 1, the parking lot identification information on the temporarily determined destination parking lot, and the expected arrival time information on the expected arrival time when the self-vehicle 1 arrives at the destination parking lot to the center 4. The present operation may be equivalent to a part of the above-described destination determining operation.

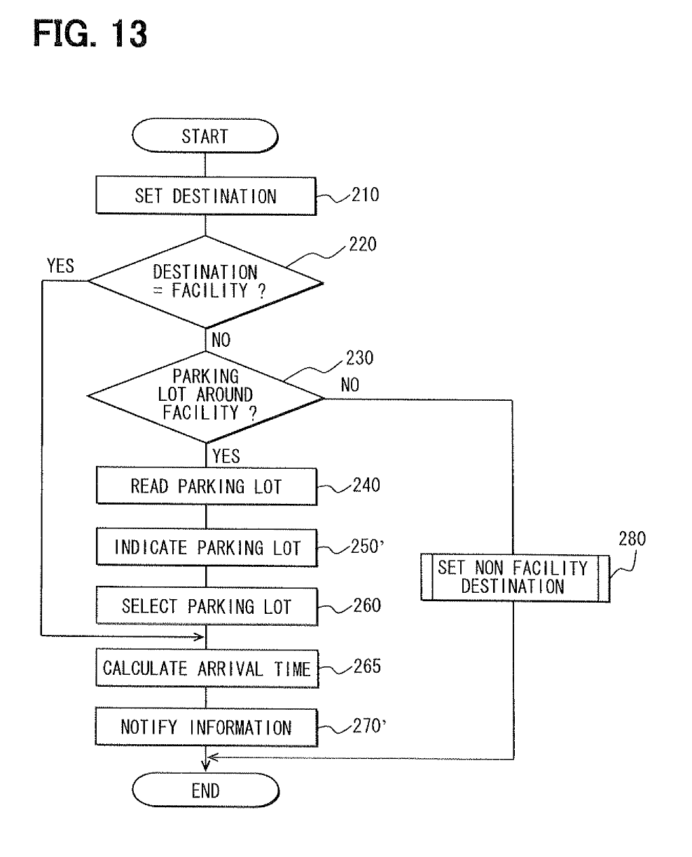

FIG. 13 is a flowchart showing a detail of an operation of temporarily determination of a destination parking lot and notification at step 108′. Steps of operations in FIG. 13 same as those in FIG. 6 in the first embodiment are denoted by the same reference numerals, and description about the same steps in FIG. 6 is omitted.

At step 210, a facility is set as a main destination. At step 230, the control circuit 17 determines whether a parking lot available for use of the facility is around the facility. When step 230 makes a positive determination, at subsequent step 240, the control circuit 17 reads parking lot identification information on all the parking lots around the facility, regardless of whether each parking lot has a parking space for disabled. When step 240 makes a positive determination, the processing proceeds to step 250′.

Similarly to step 250 in FIG. 6, at step 250′, the image display unit 12 is caused to indicate a list of information, such as a name and a location, on the parking lots read at step 240. In the present embodiment, an order of the list differs from that of step 240 in FIG. 6.

Specifically, among the parking lots read at step 240, parking lots each having a parking space for disabled is listed preferentially compared with parking lots each not having a parking space. For example, a group of parking lots each having a parking space for disabled may be allocated on the top of a scrollable list. In this way, a user is enabled to select a parking lot having a parking space for disabled further easily.

The map data stored in the map data acquisition unit 16 includes various information on each parking lot about a name, a location, a land lot number, and a facility classification. In the present embodiment, the map data further includes information on whether the parking lot has a parking space for disabled, in addition to the various information. The map data further includes information on the number of parking spaces for disabled when a parking lot has at least one parking space for disabled. The control circuit 17 is capable of discriminating a parking lot, which has a parking space for disabled, from a parking lot, which does not have a parking space, according to the information on whether the parking lot has a parking space for disabled.

In this way, when it is highly possible that a disabled person rides on the vehicle 1, a parking space for disabled can be guided preferentially among parking lots near the set main destination.

Similarly to step 270 in FIG. 6, at step 270′, the control circuit 17 transmits the signal 54 (FIG. 11, a second signal) to the center 4. The signal 54 includes the vehicle identification information on the self-vehicle, the parking lot identification information on the selected parking lot, and the expected arrival time at the parking lot calculated at step 265. It is noted that only when a user selects a parking lot having a parking space for disabled at step 260, at step 270′, predetermined parking-space-for-disabled inquiry data is included in the signal 54 in order to inquire the center 4 about an unoccupied spaces (cells) for disabled.

At step 110′ in FIG. 11, on receiving the signal 54 including the predetermined parking-space-for-disabled inquiry data, the control unit 44 of the center 4 subsequently calculates the number of expected unoccupied parking spaces (cells) for disabled in the parking lot included in the signal 54. Each unoccupied parking space (cell) for disabled corresponds to one vehicle. The control unit 44 further transmits the signal 55 to the vehicular navigation device 10. The signal 55 includes the calculated number of the expected unoccupied parking cells. When the received signal 54 does not include the parking-space-for-disabled inquiry data, the operation of step 110′ is the same as the operation of step 110 in FIG. 5.

As follows, operation of step 110′ when the received signal 54 includes the parking-space-for-disabled inquiry data will be described. The expected unoccupied parking spaces for disabled in a parking lot calculated at the step 110 is a predicted value of unoccupied parking spaces for disabled in the parking lot at an expected arrival time when the vehicle 1 arrives at the parking lot. The number of expected unoccupied parking spaces for disabled is calculated according to the number of unoccupied parking spaces for disabled (present unoccupied spaces (cells) C′) in the present parking lot and the number of other vehicles (expected parked vehicles F′) expected to be parked in the parking lot by the time point when the self-vehicle 1 arrives at the parking lot. Specifically, the number of expected unoccupied parking spaces for disabled is calculated by subtracting the expected parked vehicles F′ from the present unoccupied cells C′. It is noted that a vehicle, which does not have a function to transmit the parking lot identification information on the destination parking lot to the center 4, may be parked in the parking lot. In consideration of this, the number of expected unoccupied parking spaces for disabled may be calculated by subtracting a value, which is obtained by multiplying the expected parked vehicles F′ by a coefficient K greater than 1, from the present unoccupied spaces for disabled C′.

In the present example, the present unoccupied parking lot information on the parking lot is extracted from the VICS information received by the wireless unit 42, and the extracted present unoccupied parking lot information is employed as the present unoccupied spaces for disabled C. In the present embodiment, a parking lot having a parking space for disabled is added with information on the present unoccupied parking spaces for disabled in the parking lot in the VICS information received using the wireless unit 42.

The expected parked vehicles F′ is calculated according to the parking schedule data of the parking lot stored in the storage unit 43. Specifically, the number of entries including data, which specifies that the corresponding vehicle is to be parked at a parking space for disabled, among entries, each having expected arrival time before the expected arrival time when the self-vehicle 1 arrives at the parking lot, is obtained from the parking schedule data. In addition, the obtained number may be employed as the expected parked vehicles F′.

More specifically, the expected-parked-vehicles F′ may be calculated in the following manner. First, the total entry number N in the parking schedule data in the operation of FIG. 7 is substituted with a total entry number N′ of vehicles, which are going to be parked at a parking space for disabled, in the parking schedule data. At step 330, the control unit 44 compares an expected arrival time T(n), which corresponds to the nth entry of a vehicle, which is going to be parked in a parking space for disabled, in the parking lot expected data, with the expected arrival time T of the vehicle 1 included in the received signal 54.

The control unit 44 calculates the expected parked vehicles F. Further, the control unit 44 calculates the number of expected unoccupied parking spaces for disabled in the parking lot according to the expected parked vehicles F′ and the present unoccupied cells C′. Further, the control unit 44 transmits the signal 55 (FIG. 11) including the information on the calculated number of expected unoccupied parking spaces (cells) to the vehicle 1 through the communication network 3.

When the control circuit 17 determines that the number of the expected unoccupied parking spaces (cells) in the parking lot received from the center 4 is not less than the predetermined number at step 112, the processing proceeds to step 118. At step 118, the control circuit 17 determines the parking lot as the destination parking. Subsequently, the processing proceeds to step 119′.

At step 119′, the control circuit 17 further calculates the expected arrival time at the parking lot (determined destination). Further, the control circuit 17 transmits the signal 56 (one example of first signal) to the center 4 through the communication network 3. The signal 56 includes the vehicle identification information on the self-vehicle 1, the parking lot identification information on the parking lot, the expected arrival time at the parking lot, and information on that the vehicle is going to be parked at a parking space for disabled. The presently described operation at step 119′ is performed when a parking lot having a parking space for disabled is selected at step 260 in FIG. 13. When a parking lot not having a parking space for disabled is selected at step 260 in FIG. 13, the control circuit 17 calculates an expected arrival time at the determined destination parking lot. Further, the control circuit 17 transmits the signal 56 (one example of first signal) to the center 4 through the communication network 3. The signal 56 includes the vehicle identification information on the self-vehicle 1, the parking lot identification information on the parking lot, the expected arrival time at the parking lot, and information on that the vehicle is not going to be parked at a parking space for disabled. Subsequently, the control circuit 17 performs a route guidance operation along an optimal guidance path from the present position to the parking lot.

On receiving the signal 56, at step 120′, the control unit 44 of the center 4 updates parking schedule data of the parking lot. Specifically, the control unit 44 adds an entry, which includes a group of information included in the signal 65, to the parking schedule data corresponding to the parking lot identification information on the parking lot included in the received signal 65. The entry includes a group of the vehicle identification information, the expected arrival time information, and the information on whether the vehicle is going to be parked at a parking space for disabled. That is, entry includes information representing that the vehicle is going to be parked at a parking space for disabled or information representing that the vehicle is not going to be parked at a parking space for disabled. The new entry is added to a position, which is subsequent to all entries, each including an expected arrival time earlier than the arrival time of the new entry, and in advance of all the entries, each including an expected arrival time later than the arrival time of the new entry. The new entry is added in this way. Thereby, entries are stored in the parking schedule data in ascending order of the expected arrival time.

At step 112, when the control circuit 17 of the vehicular navigation device 10 equipped in the self-vehicle 1 determines that the received number of expected unoccupied parking cells (or expected unoccupied parking spaces for disabled) in the parking lot is less than the predetermined number, the processing proceeds to step 114. At step 115, the control circuit 17 causes the image display unit 114 and the speaker 14 to output an image and/or a voice to notify a user of information that the parking lot, which is temporarily determined as a destination, has a small number of unoccupied parking cells (or unoccupied parking spaces for disabled). Subsequently, the processing proceeds to step 115.

At step 115, the control circuit 17 causes the image display unit 114 and the speaker 14 to output an image and/or a voice to inquire a user whether the user permits setting of a parking lot for a non-disabled person, i.e., a parking lot without a parking space for disabled as the destination. The control circuit 17 waits for the user to perform an operation to the operation unit 13 to respond to the inquiry. On detection of an operation to the inquiry, the control circuit 17 determines the operation. When the operation represents that the user do not intend to set a parking lot for a non-disabled person as a destination, step 116 is executed similarly to the first embodiment. Alternatively, when the operation represents that the user permits to set a parking lot for a non-disabled person as a destination, the processing proceeds to step 117. At step 117, the priority indication of parking lots having parking spaces for disabled is terminated. That is, the listing of the parking lots having parking spaces for disabled preferentially on the top of the list is not performed. Subsequent to step 117, the preferential listing and indication of parking lots having parking spaces for disabled are not performed at step 108′ being a content of step 250′. Excluding the preferential listing and indication, contents of step 250 are the same as those of step 250 in the first embodiment. In this way, a parking lot can be guided for a user who gave up parking of a vehicle in a parking lot having a parking space for disabled. In short, when there are few parking spaces for disabled, another parking lot can be searched. In this case, a user may be guided to another parking lot when the user accepts the parking lot.

The control circuit 17 determines a facility as a main destination at step 210 in FIG. 13. In this case, at step 230, when the control circuit 17 determines that there is neither available parking lot with a parking space for disable nor available parking lot without a parking space for disable for using the facility, the processing proceeds to step 280. At step 280, the control circuit 17 executes an operation for setting a destination other than a parking lot.

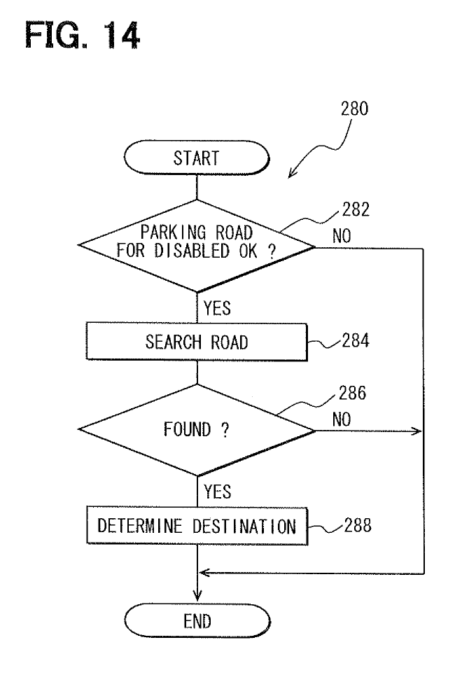

FIG. 14 is a flowchart showing details of the operation for setting a destination other than a parking lot. At step 282, the control circuit 17 causes the image display unit 114 and the speaker 14 to output an image and/or a voice to inquire a user whether the user permits guidance to a road, where only a disabled person is exempted from a no parking regulation, instead of a parking lot. Subsequently, the control circuit 17 waits for a user to perform an operation to the operation unit 13 to respond to the inquiry. On detection of an operation to respond to the inquiry, the control circuit 17 determines whether the operation represents that the user permits the guidance. When the user does not permit the guidance, the operation of step 280 is skipped, and the operation in FIG. 13 is terminated. In this case, processings subsequent to step 108′ in FIG. 11 is not executed.

Alternatively, when the user permits the guidance, the processing proceeds to step 284. At step 284, the control circuit 17 searches an on-road point on a road, in which only a disabled person is exempted from a no parking regulation, in a range of a predetermined distance such as 200 m around the main destination. Subsequently, at step 286, the control circuit 17 determines whether such an on-road point is found as a result of the search. When the control circuit 17 determines that such an on-road point is not found, the operation of step 280 is skipped, and the operation of FIG. 13 is terminated. In this case, processings subsequent to step 108′ in FIG. 11 are not executed. Alternatively, when the control circuit 17 determines that such an on-road point is found, the processing proceeds to step 288. At step 288, the control circuit 17 determines the presently found on-road point as a destination instead of the parking lot. In this case, notification to the center 4 is not performed. Subsequently, the control circuit 17 performs a route guidance operation along an optimal guidance path from the present position to the destination. In this way, when there is no parking lot around a destination and when there is a road (on-road point), where only a disabled person is exempted from a no parking regulation, near the destination, guidance can be performed on acceptance of the road (on-road point) by a user.

In the present embodiment, the control unit 44 of the center 4 executes the operations of steps 102′, 104′, 106′, 120′ to function as one example of a parking schedule data generation unit. In addition, the control unit 44 of the center 4 executes the operation of step 110′ to function as one example of an expected unoccupied state calculation unit.

The control circuit 17 of the vehicular navigation device 10 executes the operation of step 250′ to function as one example of an indication unit. The control circuit 17 of the vehicular navigation device 10 executes the operation of step 265 to function as one example of an arrival time calculation unit. The control circuit 17 of the vehicular navigation device 10 executes the operation of step 270′ to function as one example of a transmission unit. The control circuit 17 of the vehicular navigation device 10 executes the operation of step 114 to function as one example of a notification unit.

### Other Embodiment

As described above, although the embodiment has been described, the scope of the present invention is not limited to the embodiment. The scope of the present invention includes various forms, which can produce a function of each subject matter of the present invention.

For example, in the above embodiments, the unoccupied parking lot information notification system is configured of the vehicular navigation device 10, which is equipped in each of the multiple vehicles 1, 2a to 2c, and the center 4 located at a position distant from the vehicles 1, 2a to 2c. It is noted that the center 4 need not be distant from the vehicles 1, 2a to 2c. For example, each of the vehicular navigation devices 10 of the unoccupied parking lot information notification system may have a function of the center 4.

Specifically, similarly to the center 4 in this case, each of the vehicular navigation devices 10 may store the parking schedule data for each parking lot. In addition, at step 120 in FIG. 5, the vehicular navigation device 10 of the self-vehicle 1 may transmit the signal 56 not to the center 4 but to all other vehicles 2 through the communication network 3. In addition, the vehicular navigation device 10 of each of the vehicles 2a to 2c may transmit the signals 51 to 53 to all vehicles other than the self-vehicle through the communication network 3. For example, when the self-vehicle is the vehicle 2a, the vehicular navigation device 10 of the vehicle 2a may transmit the signals 51 to 53 to the vehicles 2b, 2c and the vehicle 1.

In addition, on receiving the signals 51 to 53, 56, the control unit 44 of the vehicular navigation device 10 may update part (either) of the parking schedule data stored in the self device, similarly to steps 102, 104, 106, 120 in FIG. 5.

Further, at step 108, each of the vehicular navigation devices 10 may temporarily determine a destination parking lot. In addition, each of the vehicular navigation devices 10 may calculate an expected arrival time at the destination parking lot. At this time, each of the vehicular navigation devices 10 may not transmit the signal 54, which includes the parking lot identification information and the expected arrival time of the temporarily determined parking lot, to the center 4. Rather, each of the vehicular navigation devices 10 may calculate the number of expected unoccupied parking cells in the parking lot using the parking schedule data of the parking lot stored in the self device in the same method as that of step 110. Thus, the vehicular navigation devices 10 may use the calculated number of expected unoccupied parking cells in the processings subsequent to step 112.

In the above embodiments, the vehicular navigation device 10 temporarily determines or determines a destination parking lot according to a user's operation and calculates an expected arrival time at the temporarily determined destination parking lot or the determined destination parking lot. It is noted that the center 4 may performs the present temporary determination or determination and the calculation. Specifically, the vehicular navigation device 10 may transmit a user's operation and vehicle identification information of the self-vehicle to the center 4. In this case, the center 4 may temporarily determine a destination parking lot of the vehicle or determine a destination parking lot of the vehicle. Further, the center 4 may calculate an expected arrival time at the temporarily determined destination parking lot or the determined destination parking lot according to the operation.

That is, the center 4 may include all the parking schedule data generation unit, the arrival time calculation unit, and the expected unoccupied state calculation unit. Alternatively, the vehicular navigation device 10 may include all the parking schedule data generation unit, the arrival time calculation unit, and the expected unoccupied state calculation unit. Alternatively, the center 4 may include pat of the parking schedule data generation unit, the arrival time calculation unit, and the expected unoccupied state calculation unit arbitrary, and the vehicular navigation device 10 may include remaining element(s) of the parking schedule data generation unit, the arrival time calculation unit, and the expected unoccupied state calculation unit.

In the above embodiments, at step 110 in FIG. 5, the control unit 44 of the center 4 calculates a predicted value of the number of unoccupied parking cells in a parking lot at an expected arrival time when the vehicle 1 arrives at the parking lot. It is noted that the calculated object is not limited to a predicted value of the number of unoccupied parking cells in the parking lot. The calculated object may be a predicted value of an unoccupied state of a parking lot. For example, the calculated object may be a predicted value of a usage rate of parking cells.

In the above embodiments, the control circuit 17 of the self-vehicle 1 notifies a user (occupant) in the vehicle 1 of the received predicted value of the number of unoccupied parking cells. It is noted that it suffices that a user may be notified of information based on a received predicted value of unoccupied parking cells. For example, when a predicted value of unoccupied parking cells is less than three, a user may be notified that parking lots are expected to be fully occupied.

In the above embodiments, when there are few unoccupied parking cells in a destination parking lot selected by a user, at step 116 in FIG. 5, the user is recommended to change the destination parking lot. In this case, additionally to the recommendation, the user may be provided with a suggestion (guidance) of an alternative parking lot proactively.

Specifically, it is assumed that multiple peripheral parking lots are extracted, and the extracted multiple peripheral parking lots are read at step 240 in FIG. 6. In this case, inquiry may be made about the multiple peripheral parking lots to the center beforehand to obtain the number of expected unoccupied parking cells in each of the peripheral parking lots.

Subsequently, at step 114 a user may be notified that there are few unoccupied parking cells. In addition, at step 116, the user may be recommended to change the destination. In addition, a recommendable parking lot may be suggested to the user according to the obtained number of expected unoccupied parking cells.

When the user accepts the suggestion, the processing may proceed to step 118, without returning to step 108.

In this way, when congestion is expected in a parking lot, which is temporarily selected by a user, another parking lot may be proactively suggested to the user beforehand. Therefore, congestion in a parking lot can be avoided. In addition, user's convenience can be further enhanced.

In the modification, the number of expected unoccupied parking cells is obtained. In this case, it is necessary to transmit information such as an expected arrival time to the center. Consequently, additional processing load is needed for the operation. In consideration of this, at step 260 in FIG. 6, parking schedule data about peripheral parking lots other than a parking lot selected by a user may be obtained from the center. In this case, the number of expected unoccupied parking cells may be calculated on the vehicle side. In this way, when a large number of peripheral parking lots are extracted, load caused in the communications between the vehicle and the center can be reduced.

In this case, in the second embodiment, it may be determined whether a parking space for disabled are indicated preferentially according to a grade of disability of a disabled person. Specifically, at step 430 in FIG. 10, the control circuit 17 determines whether the inputted registration ID is a registration ID of a legal disabled person ID item validly registered in a governmental office such as a prefecture office. Subsequently, the control circuit 17 may determine whether a grade (disability grade) of disability of a disabled person corresponding to the registration ID is smaller than a predetermined reference grade. When the control circuit 17 determines that the disability grade is smaller than the predetermined reference grade, the control circuit 17 may set the disabled person flag ON at step 440. Alternatively, when the control circuit 17 determines that the disability grade is not smaller than the predetermined reference grade, the control circuit 17 may terminate the disabled person recognition operation without switching the disabled person flag at step 440.

The disability grade is a value representing a degree of disability of a disabled person. As the disability grade becomes smaller, the degree of disability becomes larger, i.e., the disability becomes further serious. Information on the disability grade corresponding to each registration ID may be beforehand included in the list of the registration ID used at step 430. In the list of the registration ID, a disability grade corresponding to a certain registration ID is determined to represent a grade (reference grade) of a disabled person having the certain registration ID. The reference grade is determined arbitrarily in this way. Thereby, for example, a parking space for disabled may be indicated preferentially to a disabled person who needs a wheelchair. Alternatively, a parking space for disabled may not be indicated preferentially to a disabled person who has only a minor disability.

In the second embodiment, at step 230 in FIG. 13, the search is performed for all the parking lot information. It is noted that, at step 230 in FIG. 13, the search may be performed for parking lots each having a parking space for disability. In this case, when a user makes a positive (YES) determination at step 115 in FIG. 11, the searched object may be enlarged to all the parking lot information, and the search may be performed.

In the above embodiments, at step 230 in FIG. 13, it is determined that a facility, which is determined as a main destination, does not have an available parking lot for using the facility at step 230. When it is determined that the facility does not have an available parking lot at step 230, an on-road point, where only a disabled person is exempted, from a no parking regulation on a road, is searched according to a user's predetermined operation, and the searched on-road point is indicated on a user.

It is noted that the case, in which an on-road point where only a disabled person is exempted from a no parking regulation is searched and indicated on a user, is not limited to the above-described situation. For example, the following operation may be performed. Specifically, at step 260 in FIG. 13, a user may select a parking lot with a parking space for disabled. Subsequently, at step 270′, the control circuit 17 may transmit the signal 54 including the predetermined parking-space-for-disabled inquiry data in order to inquire the center 4 about the number of unoccupied parking spaces for disabled. Subsequently, the control circuit 17 may store in the RAM that the control circuit 17 has inquired about the number of unoccupied parking spaces for disabled. Subsequently, at step 112 in FIG. 11, the control circuit 17 determines whether the received number of expected unoccupied parking spaces for disabled is less than the predetermined number according to the response 55 to the signal 54. When step 112 makes a positive determination, at subsequent step 114, the control circuit 17 causes an image and/or a voice to notify a user that there are few unoccupied parking spaces for disabled in the temporarily determined parking lot. Immediately after that, at step 282 in FIG. 14, the control circuit 17 may output an a voice and/or an image to inquire a user whether the user permits parking of the vehicle on a road where only a disabled person is exempted from a no parking regulation instead of a parking lot, according to the information stored in the RAM that the control circuit 17 has inquired about the number of unoccupied parking spaces for disabled. Subsequently, the control circuit 17 may wait for a user's operation to the operation unit 13 to respond to the inquiry. On detection of a user's operation, when the control circuit 17 determines that the user's operation represents that the user do not want guidance, the processing may proceed to step 115. Alternatively, when the control circuit 17 determines that the user's operation represents that the user wants guidance, the processing may proceed to step 284. In this case, at step 284, the control circuit 17 may search an on-road point where only a disabled person is exempted from a no parking regulation in a range of a predetermined distance such as 200 m around the main destination. Subsequently, the processing may return to step 108′. In this case, in the operation of step 108′, at step 250′ in FIG. 13, when an on-road point, where only a disabled person is exempted from a no parking regulation, is found, the control circuit 17 may cause the image display unit 12 to indicate a list information such as the location of the on-road point together with other parking lots. Thus, the control circuit 17 may enable a user to select one from the list.

In the above embodiments, each function produced by execution of a program by the control circuit 17 and the control unit 44 may be produced by another hardware such as an field programmable gate array (FPGA), which can program a circuit structure having the function.

Summarizing the above embodiments, an unoccupied parking lot information notification system includes: a parking schedule data generation unit 102, 104, 106, 120, 102′, 104′, 106′, 120′ configured to generate parking schedule data, which includes information on an expected arrival time of a vehicle at a parking lot, for each vehicle being due to arrive at the parking lot; an arrival time calculation unit 265 configured to calculate an expected arrival time of a first vehicle 1 at the parking lot; an expected unoccupied state calculation unit 110, 110′ configured to calculate a predicted value of an unoccupied state of a parking lot at the expected arrival time of the first vehicle 1 at the parking lot, according to a number of expected parked vehicles in the parking schedule data and a present number of unoccupied parking cells in the parking lot, the number of expected parked vehicles being a number of vehicles each having an expected arrival time before the expected arrival time of the first vehicle 1 at the parking lot; and a notification unit 114 configured to provide a notification to a user of the first vehicle 1 according to the calculated predicted value of the unoccupied state.

According to the present configuration, the number of other vehicles (expected parked vehicles) 2, which are not in a parking lot presently and going to be in the parking lot before the first vehicle 1 arrives at the parking lot, can be predicted when the first vehicle 1 is going to the parking lot. Thereby, in consideration of the expected parked vehicles, a user can be notified of a quantity of unoccupied parking cells at the time point where the vehicle 1 arrives at the parking lot. Therefore, it is less possible that the vehicle finally arrives at a completely occupied parking lot, compared with determination of a parking lot according to a present unoccupied state of the parking lot.

The unoccupied parking lot information notification system may further include multiple vehicular navigation devices 10 respectively equipped in multiple vehicles 1, 2; and a center 4 located in a position distant from the multiple vehicles 1, 2. A first vehicular navigation device 10 among the multiple vehicular navigation devices 10 may be equipped in the first vehicle 1 among the multiple vehicles 1, 2. The center 4 may include the parking schedule data generation unit 102, 104, 106, 120. The parking schedule data generation unit 102, 104, 106, 120 may be further configured such that, on receiving a first signal 51, 52, 53, 56 from each of the multiple vehicular navigation devices 10, the first signal 51, 52, 53, 56 including vehicle identification information and information on the expected arrival time of the vehicle equipped with the vehicular navigation device 10 at the parking lot, the parking schedule data generation unit 102, 104, 106, 120 adds a pair of an entry including the vehicle identification information and the expected arrival time information, which are included in the received first signal 51, 52, 53, 56, to the parking schedule data. The first vehicular navigation device 10 may include the arrival time calculation unit 265 and a transmission unit 270, 270′, the transmission unit 270, 270′ configured to transmit a second signal 54 to the center 4, the second signal 54 including the expected arrival time at the parking lot calculated by the arrival time calculation unit 265 and the vehicle identification information of the first vehicle 1. The center 4 may include the expected unoccupied state calculation unit 110. The expected unoccupied state calculation unit 110 may be configured such that, on receiving the second signal 54, the expected unoccupied state calculation unit 110 calculates the predicted value of the unoccupied state and transmits the calculated predicted value of the unoccupied state to the first vehicle 1. The first vehicular navigation device 10 may include the notification unit 114. The notification unit 114 may be configured such that, on receiving the predicted value of the unoccupied state from the center 4, the notification unit 114 provides a notification to a user of the first vehicle 1 according to the predicted value of the unoccupied state.

According to the present configuration, the center 4 manages the parking lot expected data all together. Thereby, the vehicular navigation devices 10 of the vehicles need not to communicate with each other. Therefore, operation for communications can be simplified.

The unoccupied parking lot information notification system may include a parking schedule data generation unit 102′, 104′, 106′, 120′ configured to: generate parking schedule data, which includes information on an expected arrival time of a vehicle at a parking lot, for each vehicle being due to arrive at one of multiple parking lots; and add information, which is on whether the vehicle is due to be parked at a parking space for disabled, to the parking schedule data of a parking lot, which includes a parking space for disabled, among the multiple parking lots; an indication unit 250′ configured to preferentially indicate a parking lot, which has a parking space for disabled, on a user among multiple parking lots stored in a storage medium according to that a predetermined flag stored in a storage medium is ON, the predetermined flag being switchable between ON and OFF according to an operation of a user of a first vehicle 1; an arrival time calculation unit 265 configured such that, when one of the parking lots indicated by the indication unit 250′ is selected by a user, the arrival time calculation unit 265 calculates an expected arrival time at the selected parking lot; an expected unoccupied state calculation unit 110′ configured such that when the selected parking lot is a parking lot having a parking space for disabled, the expected unoccupied state calculation unit 110′ calculates a predicted value of an unoccupied state of a parking space for disabled in the parking lot at the expected arrival time of the first vehicle 1 at the parking lot, according to a number of expected parked vehicles in the parking schedule data and a number of present unoccupied parking spaces for disabled in the parking lot, the number of expected parked vehicles being a number of vehicles each being due to be parked at a parking space for disabled and having an expected arrival time before the expected arrival time of the first vehicle 1 at the selected parking lot; and a notification unit 114 configured to provide a notification to a user of the first vehicle 1 according to the calculated predicted value of the unoccupied state. According to the present configuration, a user is enabled to select a parking lot having a parking space for disabled further easily.

In the unoccupied parking lot information notification system, the indication unit 250′ may be configured to preferentially indicate a parking lot, which has a parking space for disabled, among multiple parking lots stored in the storage medium on a user according to that the predetermined flag is ON and a registration ID inputted by a user is a registration ID of a legal disabled person ID item registered beforehand.

According to the present configuration, it is possible to prohibit a user, who does not have a registration ID of a legal disabled person ID item, from invalidly receiving a preferential guidance about a parking lot having a parking space for disabled.

In the unoccupied parking lot information notification system, a point on a road, where only a disabled person is exempted from a no parking regulation, may be searched according to a predetermined operation of a user, and the searched point may be indicated on the user. According to the present configuration, the point, where only a disabled person is exempted from a no parking regulation on the road, can be indicated with an agreement of a user.

In the unoccupied parking lot information notification system, a point, where only a disabled person is exempted from a no parking regulation on the road, is searched according to that the predicted value of the unoccupied state of a parking space for disabled calculated by the expected unoccupied state calculation unit 110′ is less than the predetermined number and in response to a predetermined permission operation of a user, and the searched point is indicated on the user.

The above structures of the embodiments can be combined as appropriate. The above processings such as calculations and determinations are not limited being executed by the control circuit 17 and the control unit 44. The control unit may have various structures including the control circuit 17 and the control unit 44 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. An unoccupied parking area notification system comprising:
a parking schedule data generation unit configured to generate parking schedule data for each vehicle being due to arrive at a parking area, the parking schedule data including information on an expected arrival time of a vehicle at the parking area;
an arrival time calculation unit configured to calculate an expected arrival time of a first vehicle at the parking area;
an expected unoccupied state calculation unit configured to calculate a predicted value of an unoccupied state of the parking area at the expected arrival time of the first vehicle, according to a number of expected parked vehicles in the parking schedule data and a present number of unoccupied parking cells in the parking area, the number of expected parked vehicles being a number of vehicles each having an expected arrival time before the expected arrival time of the first vehicle; and
a notification unit configured to provide a notification to a user of the first vehicle according to the calculated predicted value of the unoccupied state.

2. The unoccupied parking area notification system according to claim 1, further comprising:
a plurality of vehicular navigation devices respectively equipped in a plurality of vehicles; and
a center located in a position distant from the plurality of vehicles, wherein
a first vehicular navigation device of the plurality of vehicular navigation devices is equipped in the first vehicle of the plurality of vehicles, wherein
the center includes the parking schedule data generation unit,
the parking schedule data generation unit is configured such that, on receiving a first signal from each of the plurality of vehicular navigation devices, the first signal including vehicle identification information and information on an expected arrival time of a vehicle equipped with the vehicular navigation device at a parking area, the parking schedule data generation unit adds a pair of an entry including the vehicle identification information and the expected arrival time information, which are included in the received first signal, to the parking schedule data,
the first vehicular navigation device includes the arrival time calculation unit and a transmission unit, the transmission unit configured to transmit a second signal to the center, the second signal including the expected arrival time at the parking area calculated by the arrival time calculation unit and the vehicle identification information of the first vehicle,
the center includes the expected unoccupied state calculation unit configured to calculate the predicted value of the unoccupied state on receiving the second signal and transmits the calculated predicted value of the unoccupied state to the first vehicle, and
the first vehicular navigation device includes the notification unit configured such that, on receiving the predicted value of the unoccupied state from the center, the notification unit provides a notification to a user of the first vehicle according to the predicted value of the unoccupied state.

3. An unoccupied parking area notification system comprising:
a parking schedule data generation unit configured to:
generate parking schedule data for each vehicle being due to arrive at one of a plurality of parking areas, the parking schedule data including information on an expected arrival time of a vehicle at a parking area; and
add information to the parking schedule data of a parking area of the plurality of parking areas, the parking area having a parking space for disabled, the information being on whether the vehicle is due to be parked at the parking space for disabled;
an indication unit configured to indicate preferentially on a user a parking area, which has a parking space for disabled, of a plurality of parking areas stored in a storage medium, according to that a predetermined flag stored in a storage medium is ON, the predetermined flag being switchable between ON and OFF according to an operation of a user of a first vehicle;
an arrival time calculation unit configured such that, when one of the parking areas indicated by the indication unit is selected by a user, the arrival time calculation unit calculates an expected arrival time at the selected parking area;
an expected unoccupied state calculation unit configured such that when the selected parking area has a parking space for disabled, the expected unoccupied state calculation unit calculates a predicted value of an unoccupied state of a parking space for disabled in the parking area at the expected arrival time of the first vehicle, according to a number of expected parked vehicles in the parking schedule data and a number of present unoccupied parking spaces for disabled in the parking area, the number of expected parked vehicles being a number of vehicles each being due to be parked at a parking space for disabled and having an expected arrival time before the expected arrival time of the first vehicle; and
a notification unit configured to provide a notification to a user of the first vehicle according to the calculated predicted value of the unoccupied state.

4. The unoccupied parking area notification system according to claim 3, wherein the indication unit is configured to indicate a parking area of the plurality of parking areas stored in the storage medium on a user, the parking area having a parking space for disabled, when the predetermined flag is ON and a registration ID inputted by a user is a registration ID of a legal disabled person ID item registered beforehand.

5. The unoccupied parking area notification system according to claim 3, wherein
an on-road point, where only a disabled person is exempted from a no parking regulation on a road, is searched according to a predetermined operation of the user, and
the searched on-road point is be indicated on the user.

6. The unoccupied parking area notification system according to claim 3, wherein
an on-road point, where only a disabled person is exempted from a no parking regulation on a road, is searched in response to a predetermined permission operation of a user when the predicted value of the unoccupied state calculated by the expected unoccupied state calculation unit is less than a predetermined number, and
the searched point is indicated on the user.

7. A method for notifying information on an unoccupied parking area, the method comprising:
generating parking schedule data for each vehicle being due to arrive at a parking area, the parking schedule data including information on an expected arrival time of a vehicle at the parking area;
calculating an expected arrival time of a first vehicle at the parking area;
extracting a number of expected parked vehicles, each having an expected arrival time before the expected arrival time of the first vehicle, from the parking schedule data;
calculating a predicted value of an unoccupied state of the parking area at the expected arrival time of the first vehicle according to the number of expected parked vehicles and a present number of unoccupied parking cells in the parking area; and
providing a notification to a user of the first vehicle according to the calculated predicted value of the unoccupied state.

8. A computer readable medium comprising instructions executed by a computer, the instructions including the method according to claim 7.

9. A method for notifying information on an unoccupied parking area, the method comprising:
generating parking schedule data for each vehicle being due to arrive at one of a plurality of parking areas, the parking schedule data including information on an expected arrival time of a vehicle at a parking area and information on whether the vehicle is due to be parked at a parking space for disabled in a parking area;
extracting a parking area having a parking space for disabled from the plurality of parking areas and indicating preferentially on a user of a first vehicle the extracted parking area when a predetermined flag stored in a storage medium is set ON by the user;
accepting one of the indicated parking areas selected by the user;
calculating an expected arrival time of the first vehicle at the selected parking area;
extracting a number of expected parked vehicles from the parking schedule data, the expected parked vehicles each being due to be parked at a parking space for disabled in the selected parking area before the expected arrival time of the first vehicle;
calculating a predicted value of an unoccupied state of a parking space for disabled in the selected parking area at the expected arrival time of the first vehicle according to the number of expected parked vehicles and a number of present unoccupied parking spaces for disabled in the selected parking area; and
providing a notification to a user of the first vehicle according to the calculated predicted value of the unoccupied state.

10. A computer readable medium comprising instructions executed by a computer, the instructions including the method according to claim 9.
